(19) United States
(12) Patent Application Publication
(10) Pub. No.: US 2026/0171066 A1
(43) Pub. Date: Jun. 18, 2026

(54) SYSTEM FOR ACTIVE NOISE CANCELLATION IN A PASSENGER COMPARTMENT OF A VEHICLE AND CORRESPONDING METHOD

(71) Applicant: FERRARI S.P.A., MODENA (IT)

(72) Inventors: Michele EBRI, Modena (IT); Tommaso BOTTI, Modena (IT); Roberta CAIAZZO, Modena (IT); Jacopo GINO, Modena (IT); Alfonso OLIVA, Modena (IT); Marco OLIVIERI, Modena (IT)

(21) Appl. No.: 19/419,381

(22) Filed: Dec. 15, 2025

(30) Foreign Application Priority Data
Dec. 17, 2024 (IT) 102024000028776

(51) Int. Cl. G10K 11/178

(52) U.S. Cl. CPC G10K 11/17881

(57) ABSTRACT

An active noise cancellation system in a passenger compartment (of a vehicle is provided with: reference sensors designed to detect noise reference signals indicative of ambient noise to be cancelled; error sensors, arranged within the passenger compartment, so as to detect error signals at noise cancellation zones for the purpose of a feedback control of the noise cancellation; speakers designed to reproduce sounds within the passenger compartment; and a digital processing unit, designed to control the speakers to generate anti-noise signals to be reproduced in the passenger compartment, for the purpose of noise cancellation, by implementation of a noise cancellation algorithm based on the reference signals and the error signals and on the determination of acoustic paths in the passenger compartment. In particular, the system has a distributed intelligence, wherein the reference sensors and/or the error sensors are internally provided, in an embedded manner, with digital processing capabilities and are configured to contribute, in cooperation with the digital processing unit, to the implementation of the noise cancellation algorithm.

### CROSS-REFERENCE TO RELATED APPLICATIONS

This patent application claims priority from Italian patent application no. 102024000028776 filed on Dec. 17, 2024, the entire disclosure of which is incorporated herein by reference.

### TECHNICAL FIELD

This solution relates to an improved system for active noise cancellation in a passenger compartment of a vehicle, in particular of a motor vehicle, and to a corresponding method.

### PRIOR ART

The use of active road noise cancellation (ARNC) techniques in modern motor vehicles is known, which are aimed at reducing the noise in the passenger compartment, mainly due to the rolling noise of the motor vehicle's tyres and to aerodynamic noise.

Active noise cancellation techniques generally make it possible to actively reduce acoustic noise by generating, by means of speakers within the passenger compartment, signals with waveforms that are inverted relative to those of noise (for example, with the same sound level or amplitude and inverted phase), also called “anti-phase” or “anti-noise” waveforms.

An active noise cancellation system generally uses one or more reference sensors to detect external noise reference signals, generates anti-noise signals based on the noise reference signals and reproduces the anti-noise signals through one or more speakers in the passenger compartment. These anti-noise signals destructively interfere with the original noise signals, so as to reduce the level of noise that reaches the ear of a listener (driver or passenger of the motor vehicle). The active noise cancellation system further comprises one or more error sensors, arranged in the passenger compartment to detect a residual noise, following the destructive interference operation.

The aforementioned techniques for the active cancellation of noise in the passenger compartment of a motor vehicle require the determination of acoustic paths, in particular so-called secondary acoustic paths, which represent the path of the anti-noise signals from the speakers emitting the anti-noise signals towards noise cancellation zones, generally located at the listener's ears (near the seat headrest); and possibly so-called primary paths, which represent the path of the noise signals from the noise source towards the aforementioned noise cancellation zones. These techniques also entail the implementation of noise cancellation algorithms based on the aforementioned acoustic paths and typically on a hybrid “feedforward” control, which combines the typical structure of open-loops controls with a feedback of the error signal.

In general, noise cancellation algorithms are quite complex and expensive in terms of computational resources.

Therefore, a compromise is typically required between the performance of the algorithms, in terms of noise cancellation results, and the computational effort required of a relative processing unit in the motor vehicle (which typically is also dedicated to other functions within the same motor vehicle).

### OBJECT OF THE INVENTION

The aim of this solution is, in general, to provide a system for active road noise cancellation, which can overcome or in any case limit the problems previously highlighted.

In accordance with the object indicated above, according to this solution, a system and a method are provided, as defined in the appended claims.

### BRIEF DESCRIPTION OF THE DRAWINGS

The invention will now be described with reference to the accompanying drawings showing a non-limiting embodiment thereof, wherein:

FIG. 1 shows a motor vehicle provided with an active road noise cancellation system;

FIG. 2 is a schematic block diagram of an active noise cancellation algorithm;

FIGS. 3 and 4 show block diagrams relating to an architecture of the noise cancellation system, according to an aspect of this solution; and

FIG. 5 shows a flowchart of operations for optimising a positioning of noise sensors in the motor vehicle, according to a further aspect of this solution.

### DETAILED DESCRIPTION OF THE EMBODIMENTS

As described in detail below, an aspect of this solution entails, in general, implementing a system for active road noise cancellation inside a passenger compartment of a vehicle, which has a distributed intelligence and which thereby allows to decrease a computational effort required of a corresponding processing unit within the vehicle and/or to increase the noise cancellation performance. At least part of the processing required by the noise cancellation algorithms is in fact implemented in an embedded manner within sensors (in particular, reference sensors and/or error sensors), operatively coupled to the aforementioned processing unit and used in the same active noise cancellation system.

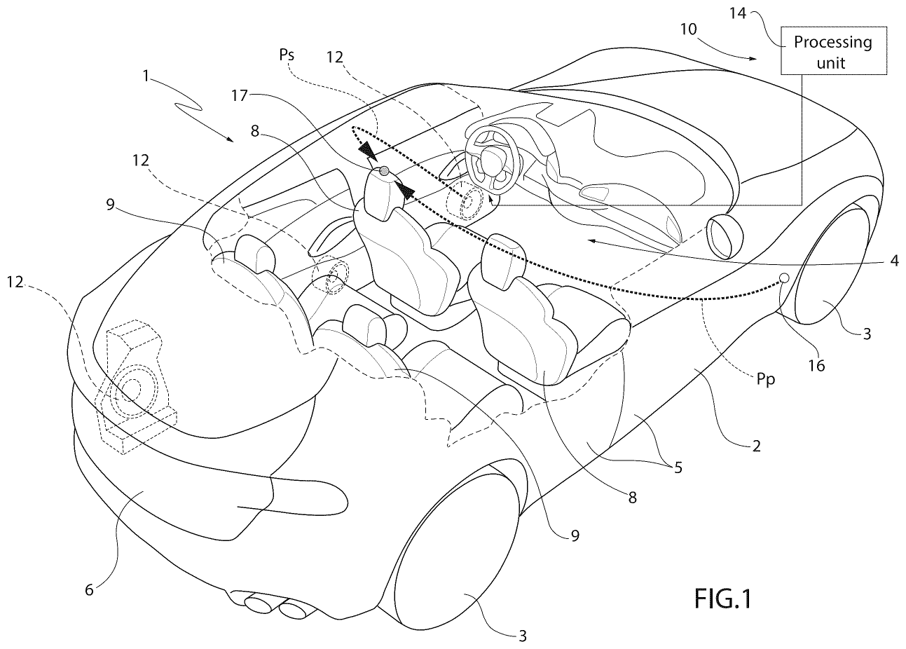

FIG. 1 shows a vehicle, in particular a motor vehicle 1 (which can be of a traditional or combustion type, hybrid or electric), provided with a body 2 resting on the ground by means of wheels 3, defining a passenger compartment 4 and comprising front and rear doors 5, which allow access to the passenger compartment 4, and a hatchback door 6, which allows access to a corresponding trunk.

Inside the passenger compartment 4, the motor vehicle 1 comprises a pair of front seats 8, arranged at the front (with respect to the direction of travel) and intended to accommodate the driver of the motor vehicle 1 and a passenger; and rear seats 9, arranged at the back (with respect to the direction of travel).

In particular, the motor vehicle 1 comprises an active road noise cancellation system (hereinafter briefly referred to as ARNC system) 10, which is typically part of an audio system of the motor vehicle 1, configured to reproduce sound signals inside the passenger compartment 4 and comprising, for this purpose, a plurality of speakers 12, having in a known manner different frequency contributions (for example, midrange speakers, tweeters, etc.), typically arranged at the doors 5; in the example shown, the audio system further comprises a woofer, arranged at the trunk.

The ARNC system 10 comprises a digital processing unit 14 (with a microprocessor, microcontroller or the like), configured to control the aforementioned speakers 12 to generate signals to be reproduced in the passenger compartment 4, in particular for the purpose of road noise cancellation.

In a possible implementation, this digital processing unit 14 may coincide with, or be part of, a control and management unit of the audio system or, in general, of an infotainment system of the motor vehicle 1, designed to control, in a known manner, the generation of (information and entertainment) digital audio-video content and possibly the activation, adjustment or monitoring of various functions of the motor vehicle 1 (for example, the management of air conditioning or the control of data associated with the operation of the motor vehicle 1).

The digital processing unit 14 can also be operatively coupled to an electronic control unit (ECU) of the motor vehicle 1, designed to supervise the general operation of the motor vehicle 1 (in a known manner, not shown herein).

The ARNC system 10 further comprises: reference sensors 16, for example audio sensors or microphones, but more often accelerometers in automotive applications, typically arranged outside the passenger compartment 4, configured to detect reference signals, indicative of the ambient noise to be cancelled; and error sensors 17, for example audio sensors or microphones, arranged within the passenger compartment 4 of the motor vehicle 1, configured to detect error signals at noise cancellation zones (for the purpose of a feedback control of the noise cancellation, as discussed below).

In a possible implementation, the error sensors 17 are arranged at the headrests of the front seats 8 (and possibly of the rear seats 9), so as to provide a detection at the noise cancellation zones that correspond to the ears of the users of the motor vehicle 1 (at least of the driver).

The reference sensors 16 can be arranged, for example, at the wheels 3 of the motor vehicle 1, so as to provide a detection associated with the ambient noise, for example associated with tyre rolling noise or with the aerodynamic noise (further details on the possible positioning of such reference sensors 16 will be provided below).

The aforementioned digital processing unit 14 is configured to implement noise cancellation algorithms in the passenger compartment 4, which entail, among other features, the determination of acoustic paths within the passenger compartment 4 of the motor vehicle 1 and of corresponding frequency transfer functions.

In particular, as schematically shown in FIG. 1, these acoustic paths can comprise: primary acoustic paths, indicated with Pₚ, which define transfer functions between a respective reference sensor 16 and a respective error sensor 17; and secondary acoustic paths, indicated with Pₛ, which define a transfer function between a respective speaker 12 within the passenger compartment 4 and a respective error sensor 17 (the aforementioned primary acoustic paths typically are indirectly determined by the algorithm).

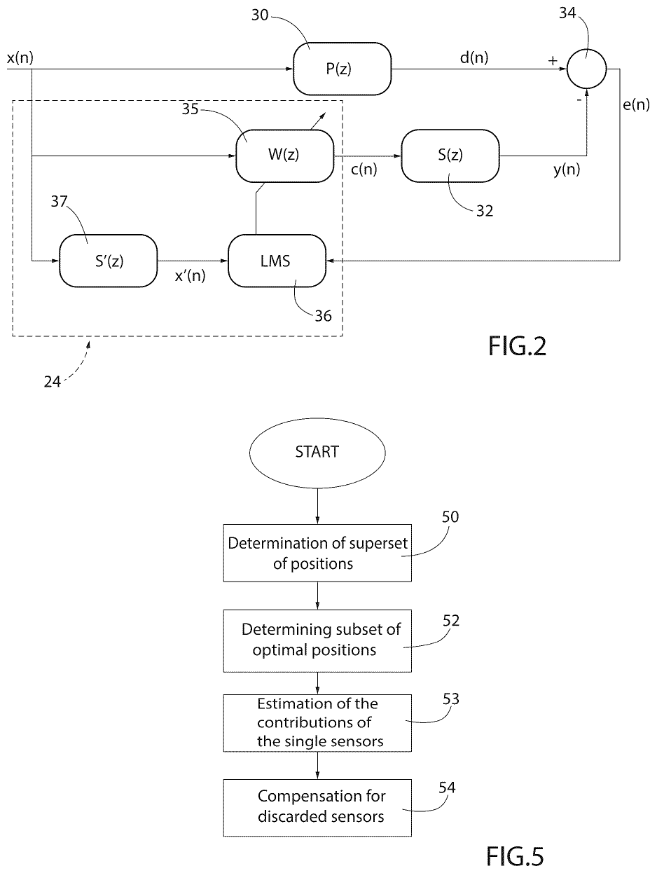

The digital processing unit 14 is configured to implement, based on these acoustic paths and on the signals detected by the aforementioned reference sensors 16 and error sensors 17, an active noise cancellation stage, in particular by means of ARNC algorithms; FIG. 2 shows a possible implementation of this noise cancellation stage, indicated with 24.

In particular, in FIG. 2, a first transfer block 30 represents the transfer function of a primary acoustic path P(z), which models the transmission of the noise signal between the noise source and the noise cancellation zone, namely between a respective one of the reference sensors 16 and a respective one of the error sensors 17.

This first transfer block 30 schematically receives a noise reference signal x(n), provided by the aforementioned reference sensor 16, and outputs a primary disturbance signal d(n), which represents the noise to be cancelled at the noise cancellation zone.

A second transfer block 32 represents the transfer function of a secondary acoustic path S(z), which models the transmission of the audio signal between a respective speaker 12 and the aforementioned noise cancellation zone.

This second transfer block 32 schematically receives a control signal c(n), which represents the signal provided to the aforementioned speaker 12, and outputs an anti-noise signal y(n).

FIG. 2 also shows a difference block 34, which schematically receives the aforementioned primary disturbance signal d(n) at a sum input and the anti-noise signal y(n) at a difference input, so as to output an error signal e(n) (this signal being detected by the aforementioned error sensors 17).

In detail, the noise cancellation stage 24 comprises: a control filter block 35, configured to receive, as an input, the noise reference signal x(n) and to generate, as an output, the aforementioned control signal c(n); and an adaptation block 36, configured to suitably adapt the filtering action performed by the control filter block W(z), for example by modifying weights, coefficients and/or transfer function.

This adaptation block 36 can operate, for example, by means of an LMS (Least Mean Squares)algorithm, or by means of a similar adaptive algorithm, and receives, as an input, the aforementioned error signal e(n), typically detected by one of the aforementioned error sensors 17, and also a filtered noise reference signal x′(n).

The noise cancellation stage 24 comprises, to this regard, an estimation block 37, which receives, as an input, the noise reference signal x(n) and outputs the filtered noise reference signal x′(n), implementing a secondary acoustic path estimation S′(z).

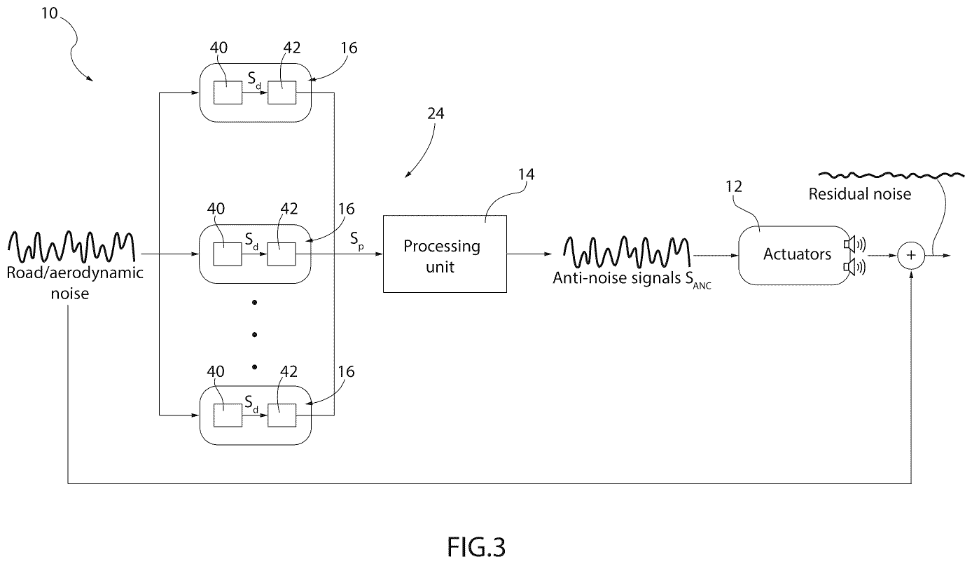

According to a particular aspect of the solution, as schematically shown in FIG. 3, the ARNC system 10 has a distributed intelligence, with the sensors used in the same ARNC system 10 (in the embodiment there are shown, by way of example, the aforementioned reference sensors 16) which are internally provided, in an embedded manner, with digital processing capabilities and contribute, in cooperation with the aforementioned digital processing unit 14, to the implementation of the aforementioned noise cancellation stage 24 and of the corresponding noise cancellation algorithms, performing at least part of the required processing.

In particular, the sensors (in the example, the aforementioned reference sensors 16) comprise, in addition to a sensing stage 40, configured to provide detection signals S_{d} according to quantities to be detected (in the specific case, external noise reference signals associated with rolling noise and/or the aerodynamic noise), a processing stage 42, operatively coupled to the sensing stage 40 and configured to perform appropriate processing of the detection signals S_{d} to generate, according to the same detection signals S_{d}, pre-processed signals Sₚ, which are then provided, as an input, to the digital processing unit 14 (representing the aforementioned noise reference signals x(n)).

This processing stage 42 can be of a digital type, for example including a DSP-Digital Signal Processor, a microcontroller or an MLC-Machine Learning Core processor or similar digital processing unit provided in an embedded manner.

The aforementioned sensing stage 40 can optionally include, in addition to a first sensing structure, typically an accelerometer structure (having one or more detection axes), further sensing structures for other quantities of interest, for example defining a microphone and/or a gyroscope.

In a possible implementation, the aforementioned reference sensors 16 are implemented as smart sensors of the MEMS (Micro-Electro-Mechanical System) type, using microfabrication technologies of semiconductor materials.

The digital processing unit 14 of the ARNC system 10 receives the pre-processed signals Sₚ from the aforementioned reference sensors 16 and performs appropriate further processing for the generation of noise cancellation signals, indicated with S_{ANC} (corresponding to the aforementioned anti-noise signals y(n)).

These noise cancellation signals S_{ANC} are provided, as an input, to one or more of the aforementioned speakers 12 for generation in the passenger compartment 4, at the noise cancellation zones, of the anti-noise signals designed to destructively interfere with the original noise signals, so as to reduce a residual noise level reaching the listener's ear.

FIG. 4 shows a possible implementation of the architecture of the ARNC system 10 in the passenger compartment 4 of the motor vehicle 1, which in this case comprises four smart sensors (in the example, reference sensors 16, arranged at the four wheels 3 of the motor vehicle 1, not shown herein), each of the smart type, namely provided in an embedded manner with the aforementioned processing stage 42 (schematically indicated).

In the example shown, these reference sensors 16 can perform detection functions not only as an accelerometer (“acc”), but also as a microphone and/or as a gyroscope (“gyro”) and are configured to detect the quantities of interest and output the pre-processed signals Sₚ, according to the pre-processing of the detection signals S_{d}.

The ARNC system 10 further comprises: in the example shown, five actuators or speakers 12, arranged at the (front and rear) doors 5 and at the trunk of the motor vehicle 1; and the digital processing unit 14, which is operatively coupled to the smart sensors (in the example, reference sensors 16), from which it receives the pre-processed signals Sₚ (possibly in addition to the original detection signals S_{d}), and also to the speakers 12, which the same digital processing unit 14 drives with the noise cancellation signals S_{ANC} for the generation of the anti-noise waveforms.

Advantageously, the distributed signal processing for the purpose of noise cancellation, implemented jointly and in cooperation by the digital processing unit 14 and the smart sensors, allows to achieve: a reduction in latencies thanks to the parallel data processing (by the processing stages 42 of the smart sensors and the digital processing unit 14); an increase in the performance of the implemented noise cancellation algorithm, or, with the same performance of the noise cancellation algorithm, the use of less computationally performing components for the implementation of the digital processing unit 14; a less complex architecture and wiring of the sensor network (for example, the smart sensors can be connected to each other with a “star centre” mode, before being connected to the digital processing unit 14 and/or the same smart sensors can be connected to the digital processing unit 14 by means of a respective single connection line, regardless of the number of detection channels used).

More in detail, the aforementioned processing stage 42 of the reference sensors 16 can be configured with DSP (Digital Signal Processing) functions, performing signal processing functions that can, for example, include one or more of:
-FFT (Fast Fourier Transform) frequency transform operations of the detection signals S_{d}, so as to propagate to the digital processing unit 14 signals already in the frequency domain (hence, without the same digital processing unit 14 having to carry out these frequency transformation operations);
-convolution operations, for example to filter the detection signals S_{d} through the estimates of the secondary acoustic path S′(z) outputting the filtered noise reference signals x′(n) that are directly provided to the digital processing unit 14 as the aforementioned pre-processed signals Sₚ (in the example, the estimation block 37 of the noise cancellation stage 24, described with reference to FIG. 2, may in this case be directly implemented within the processing stage 42 embedded in the smart sensors);

-operations of computation of multiple coherence, for example to assign respective weights to the noise reference signals acquired by the various reference sensors 16 for the purpose of noise cancellation operations.

Alternatively or in addition, the processing stage 42 of the smart sensors can be configured to implement artificial intelligence (AI) and machine learning algorithms and architectures, performing functions that can, for example, include one or more of:
-operations for combining the noise reference signals based on multiple coherence criteria using a deep learning model (with a consequent reduced computational cost for the digital processing unit 14, which can receive high-coherence pre-processed signals as an input);

-operations for synthesizing the filtered noise reference signals x′(n) from the detection signals S_{d} with a deep learning model capable of predicting the values thereof;

-operations for estimating a contribution to the total noise to be cancelled for the respective sensors, with a deep learning model (with the digital processing unit 14 which can in this case combine these estimates to consequently determine the control action).

According to an aspect of the present solution, the smart sensors (for example, the aforementioned reference sensors 16) can be optimized, in particular with regard to the operating characteristics of the corresponding processing stages 42, “off-line”, namely in a preliminary step, which can also be computationally intense, prior to their actual use during operation of the ARNC system 10 as the motor vehicle 1 is travelling.

In a subsequent step, of on-line usage, namely during the operation of the ARNC system 10 and during the travel of the motor vehicle 1, the reference sensors 16 can then process the information based on the previous optimizations and adjustments.

Advantageously, the calibration operations of the noise cancellation algorithm may not end in the aforementioned off-line step.

The ARNC system 10 can in this case be updated over time as the conditions change, continuously during the operation of the motor vehicle 1, so that the noise cancellation is optimized and calibrated (or “fine-tuned”) on-board the motor vehicle 1.

In particular, the optimization of the sensors can remain active during the user experience and the noise cancellation algorithm can be updated accordingly.

In case of implementation of artificial intelligence algorithms by the processing stage 42 of the smart sensors, the training of the neural networks used by the deep learning models can be performed in the aforementioned off-line step and, advantageously, implemented continuously over time also during on-line use.

The neural networks can be trained to predict the noise to be cancelled in the off-line training step, so as to minimize the computational effort required of the smart sensors during on-line use; in particular, the neural networks can be trained to predict the noise to be cancelled starting from the noise reference signals that the reference sensors 16 are designed to acquire (the aforementioned detection signals S_{d}).

Advantageously, the training may not end in the off-line step, but it may continue during the operation of the ARNC system 10, maintaining stable performance even when the operating conditions associated with the operation of the motor vehicle 1 change.

In particular, each neural network can be trained starting from a dataset that can be divided into:
training set, which is the part of the dataset used for training with data acquired through a measurement step;
test set, which is the part of the dataset used to test the performance of the neural network, also acquired through a measurement step.

The training set can be divided, in turn, into input data and output data, which constitute known inputs corresponding to known outputs. The neural network can thus “learn” the relationship between inputs and outputs, so as to be able to predict the outputs corresponding to future inputs that are not part of the training dataset.

The performance can be validated in a second measurement step on the motor vehicle 1.

According to an aspect of the present solution, the use of artificial intelligence algorithms by the smart sensors (for example, the aforementioned reference sensors 16) can also allow for an optimization of the positioning of the sensors in the motor vehicle 1, in particular at positions that are optimized for subsequent noise cancellation operations.

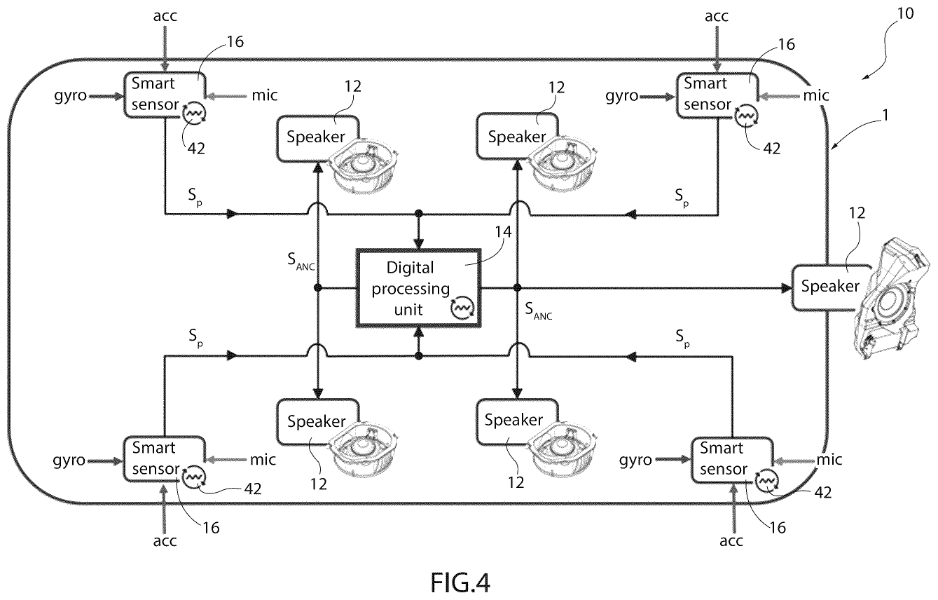

As shown in FIG. 5, an algorithm for optimizing this positioning can entail, in a first step 50, the determination of a first large set (so-called “superset”) of positions for the smart sensors (for example, for the reference sensors 16), by means of techniques (known per se, not described in detail herein) that involve: a characterization of the main vibroacoustic paths responsible for the structural transmission of the noise in the passenger compartment 4 of the motor vehicle 1; the characterization of aeroacoustic contributions; and/or the characterization of the noise source.

In a subsequent step 52, starting from the aforementioned superset of positions, a subset of optimal positions can be identified, which minimize the prediction error of the overall noise to be cancelled by the individual smart sensors through the trained neural networks implemented in the respective processing stages 42.

In particular, as indicated in step 53, a neural network can be trained (for each sensor), which estimates the single contribution to the multiple coherence, so as to select the optimal subset of sensors.

Subsequently, step 54, the neural networks of the smart sensors associated with the optimal subset that was previously identified can be trained to “compensate” for the information contribution given by the superset sensors that were instead discarded by the optimization process.

Therefore, this optimization procedure makes it possible to determine the optimal positioning of the smart sensors for the purpose of noise cancellation, which results in the best compromise between performance and use of resources.

Based on the above, the advantages that the present allows to achieve are evident.

In any case, it should be noted again that this solution allows, thanks to the distribution or division of the noise signal processing operations between the smart sensors and the actual digital processing unit 14, a reduction in the computational cost for the digital processing unit 14.

This, in turn, can lead to the use of less computationally performing components or to the increase of complexity of the noise cancellation algorithm (in terms of, for example, number of channels, complexity of the filters, use of strategies that require complex processing, etc.), optimizing the performance of the cancellation system, in particular with reference to the positions actually occupied by the driver or passengers within the passenger compartment 4.

As previously indicated, it can also be advantageous, at the expense of an increase in the computational cost (which is still advantageous compared to traditional solutions), to perform the calibration of the cancellation algorithm continuously over time, with the system that can be updated as the conditions of the motor vehicle 1 change (guaranteeing a stability of the performance over time).

Finally, it is clear that the solution described above can be subjected to changes and variants, without for this reason going beyond the scope of protection of the invention, as defined in the appended claims.

In particular, it should be noted that, as indicated above, in a possible implementation, the aforementioned distributed intelligence could alternatively or in addition be implemented by means of the error sensors 17 of the ARNC system 10, which could similarly be internally provided, in an embedded manner, with digital processing capabilities and contribute, in cooperation with the aforementioned digital processing unit 14, to the implementation of the noise cancellation stage 24 and of the corresponding noise cancellation algorithms.

In this case, these error sensors 17 would therefore be equipped with the aforementioned processing stage 42, operatively coupled to a respective sensing stage 40 and configured to perform appropriate processing of the respective detection signals S_{d} to generate, according said detection signals S_{d}, pre-processed signals Sₚ, which are provided as an input to the digital processing unit 14 (in a manner altogether similar to what described above for the reference sensors 16).

Furthermore, it should be noted that the solution disclosed herein can be used in various types of applications, even different from the examples described in detail above, in general whenever noise cancellation is required within the passenger compartment of a vehicle (of any kind).

1. An active noise cancellation system (10) in a passenger compartment (4) of a vehicle (1), comprising:
reference sensors (16) configured to detect noise reference signals indicative of ambient noise;
error sensors (17), arranged within the passenger compartment (4), configured to detect error signals at noise cancellation zones for a feedback control of the noise cancellation;
speakers (12) configured to reproduce sounds within the passenger compartment (4); and
a digital processing unit (14) configured to control the speakers (12) to generate anti-noise signals to be reproduced in the passenger compartment (4) for the purpose of the noise cancellation, by implementation of a noise cancellation algorithm based on said noise reference signals and said error signals and on the determination of acoustic paths in the passenger compartment (4),
characterized by having a distributed intelligence, wherein said reference sensors (16) and/or said error sensors (17) are internally provided, in an embedded manner, with digital processing capabilities and are configured to contribute, in cooperation with said digital processing unit (14), to the implementation of said noise cancellation algorithm.

2. The system according to claim 1, wherein said reference sensors (16) and/or said error sensors (17) comprise: a sensing stage (40), configured to provide detection signals (Sd); and a processing stage (42), operatively coupled to the sensing stage (40) and configured to perform processing of the detection signals (Sd) to generate, as a function of said detection signals (Sd) and based on said noise cancellation algorithm, pre-processed signals (Sp) designed to be provided as an input to said digital processing unit (14).

3. The system according to claim 2, wherein said processing stage (42) includes a DSP-Digital Signal Processor, a microcontroller or an MLC-Machine Learning Core processor or similar digital processing unit provided in an integrated manner with said sensing stage (40).

4. The system according to claim 2, wherein said digital processing unit (14) is configured to receive the pre-processed signals (Sₚ) from said reference sensors (16) and/or said error sensors (17) and perform further processing based on said noise cancellation algorithm for generating noise cancellation signals (S_{ANC}), designed to be provided as an input to one or more of said speakers (12) for generation in the passenger compartment (4), at noise cancellation zones, of said anti-noise signals designed to destructively interfere with noise signals, so as to define a residual noise level reaching a listener's ear.

5. The system according to claim 2, wherein said processing stage (42) is configured to filter the detection signals (S_{d}) through an estimation of a secondary acoustic path (S′(z)) in said passenger compartment (4), defined between a respective one of said speakers (12) and a respective one of said error sensors (17), and to output to said digital processing unit (14) filtered noise reference signals (x′(n)), as said pre-processed signals (Sₚ).

6. The system according to claim 5, wherein said digital processing unit (14) is configured to implement a noise cancellation stage (24), comprising: a control block (35), configured to output a control signal (c(n)) designed to drive at least one of said speakers (12) so as to generate said anti-noise signals; and an adaptation block (36), configured to adapt the operation of the control block (35) according to said filtered noise reference signals (x′(n)) received from said processing stage (42).

7. The system according to claim 2, wherein said processing stage (42) is configured with DSP functions so as to perform signal processing operations including one or more of: FFT-Fast Fourier Transform-frequency transform operations on said detection signals (S_{d}); convolution operations, so as to filter the detection signals (S_{d}) through estimates of a secondary acoustic path (S′(z)) in said passenger compartment (4) and output filtered noise reference signals (x′(n)); operations of computation of multiple coherence, to assign respective weights to the noise reference signals acquired by the reference sensors

(16) for the purpose of the noise cancellation operations.

8. The system according to claim 2, wherein said processing stage (42) is configured to implement artificial intelligence and machine learning algorithms and perform operations including one or more of: operations for combining the noise reference signals acquired by the reference sensors (16) based on multiple coherence criteria using a deep learning model; operations for synthesizing filtered noise reference signals (x′(n)) from said detection signals (S_{d}) using a deep learning model; operations for estimating a contribution to a total noise to be cancelled for the respective reference sensors (16), using a deep learning model.

9. The system according to claim 7, wherein said processing stage (42) is designed to be optimized “off-line”, in a preliminary phase, preceding the use during operation of the system (10) while the vehicle is running (1); and wherein in a subsequent phase, of on-line use, i.e., during operation of the system (10) and while the vehicle is running (1), said processing stage (42) is configured to update over time as the vehicle operating and functioning conditions change (1).

10. The system according to claim 2, wherein said processing stage (42) is configured to contribute to the implementation of an optimization algorithm for positioning of said reference sensors (16) and/or said error sensors (17) with respect to the vehicle (1), at positions optimized for the noise cancellation operations; said optimization algorithm envisaging the determination of an initial large set of positions for said reference sensors (16) and/or error sensors (17); and subsequently, from said initial large set of positions, the identification of a subset of optimal positions that minimize a prediction error of the overall noise to be cancelled.

11. A vehicle (1), comprising the active noise cancellation system (10) according to claim 1.

12. An active noise cancellation method in a passenger compartment (4) of a vehicle (1), comprising:
detecting, by means of reference sensors (16), noise reference signals indicative of an ambient noise to be cancelled;
detecting, by means of error sensors (17) arranged within the passenger compartment (4), error signals at noise cancellation zones for the purpose of feedback control of the noise cancellation;
controlling, by means of a digital processing unit

(14) speakers (12) to generate anti-noise signals to be reproduced in the passenger compartment (4), for the purpose of noise cancellation, by implementing a noise cancellation algorithm based on said noise reference signals and said error signals and on the determination of acoustic paths in the passenger compartment (4),
characterized in that controlling includes implementing a distributed intelligence, wherein said reference sensors (16) and/or said error sensors (17) are internally provided, in an embedded manner, with digital processing capabilities and are configured to contribute, in cooperation with said digital processing unit (14), to the implementation of said noise cancellation algorithm.

13. The method according to claim 12, comprising: by said reference sensors (16) and/or error sensors (17), generating pre-processed signals (Sₚ) according to detection signals (S_{d}) and based on said noise cancellation algorithm; and performing, by said digital processing unit (14), further processing of said pre-processed signals (Sₚ) for the generation of noise cancellation signals (S_{ANC}), designed to be provided as an input to one or more of said speakers (12) for generation in the passenger compartment (4), at noise cancellation zones, of said anti-noise signals designed to destructively interfere with noise signals, so as to define a residual noise level reaching a listener's ear.

14. The method according to claim 13, further comprising, by said reference sensors (16) and/or error sensors (17), filtering the detection signals (S_{d}) through estimates of a secondary acoustic path (S′(z)) in said passenger compartment (4), providing as an output to said digital processing unit (14) filtered noise reference signals (x′(n)), as said pre-processed signals (Sₚ).

15. The method according to claim 12, comprising implementing an optimization algorithm for optimizing the positioning of said reference sensors (16) and/or said error sensors (17), relative to the vehicle (1), at positions optimized for the noise cancellation operations; wherein said optimization algorithm envisages determining a first large set of positions for said reference sensors (16) and/or error sensors (17); and then, from said first large set of positions, identifying a subset of optimal positions that minimize a prediction error of the overall noise to be erased.
